(19) United States
(12) Patent Application Publication
(10) Pub. No.: US 2007/0250332 A1
(43) Pub. Date: Oct. 25, 2007

(54) Water treatment facility and filtration matching method

(76) Inventor: Cyril Charles Landise, Chicago, IL (US)

Correspondence Address: Robert M. Mason;Mason & Petruzzi, 13601 Preston Rd., 402W, Dallas, TX, 75240, US

(21) Appl. No.: 11/406,991

(22) Filed: Apr. 19, 2006

(51) Int. Cl. G06Q 10/00; G06Q 30/00

(52) U.S. Cl. 705/1

(57) ABSTRACT

A method of matching water supply systems with water filtration systems includes having a user provide area location identification, determining the water supply system for the identified area, referencing available water specifications for the water supply system, and providing the user with a recommendation of one or more water filtrations system. The method can also prove the user information on purchasing and or installing one or more of the recommended one or more water filtrations systems.

### BACKGROUND OF THE INVENTION

This invention relates generally to water filtration systems, and more particularly to a method of matching water filtrations systems based on the water treatment facility supplying the water.

There is currently registered over 20,000 water filtration systems in the United States. Each filtration system provides water with a somewhat unique set of chemical and mineral specifications. To counter certain elements in the water supply, users often purchase and install in their homes or otherwise water filtrations systems. Unfortunately, there are numerous water filtration manufactures that offer many water filters, each directed to work best with a certain water chemical and mineral composition. No filtration system is designed for a particular water supply, so it is particularly difficult for users to easily determine which water filtrations system or systems is best for their water supply.

### BRIEF SUMMARY OF THE INVENTION

It is an advantage of the present invention to provide users with a convenient and easy method of determining appropriate water filtration systems based on their water supply systems.

It is a further advantage of the present invention to match appropriate water filtrations systems with water supply systems.

In accordance with a preferred embodiment of the present invention, a method of matching water supply systems with water filtration systems comprises the steps of having a user provide area location identification, determining the water supply system for the identified area, referencing available water specifications for the water supply system, and providing the user with a recommendation of one or more water filtrations systems.

Other objects and advantages will become apparent from the following descriptions, taken in connection with the accompanying drawings, wherein, by way of illustration and example, an embodiment of the present invention is disclosed.

### BRIEF DESCRIPTION OF THE SEVERAL DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram showing the steps of the matching system and method of a preferred embodiment of the present invention.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

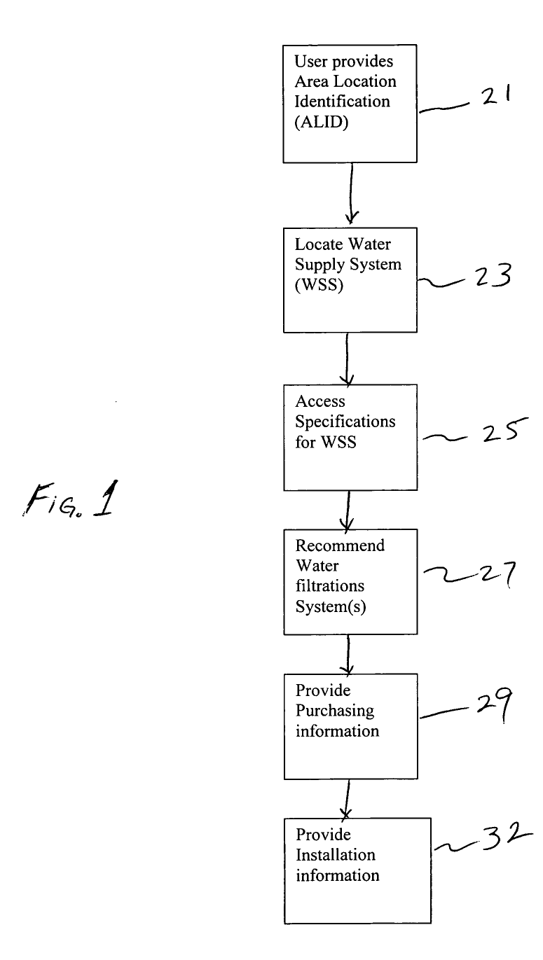

Turning now to FIG. 1, there is shown a block flow diagram of the water to filter matching system of a preferred embodiment of the present invention. At the first step 21, a user identifies their location such as by entering a zip code, address, area code, or other area location identification information. The present invention uses the location information at step 21 to determine the appropriate water supply system (WSS) at step 23 supplying water for the particular area identified by the user. After identifying the WSS supplying the user's water, the present invention next accesses the specifications associated with that water filtration system at step 25. In particular, there are often specifications that are available to the public or specifications that can be obtained otherwise. The specifications accesses at step 25 may include chemical analysis of the water supplied, and may also include information relating to the times the water supplied varied form Federal Drug Administration requirements or recommendations such as the frequency of occurrences, the duration of occurrences, the magnitude out of FDA requirement or recommendation, and/or other criteria.

Based upon the specifications at step 25 for the water supply system supplying water to the user's area, the present invention next recommends one or more water filtration systems at step 27. Such recommendation can include particular features of the water filtration system that work in one or more particular ways in connection with the water supply system for the user's area.

In the event the user's area is supplied by a water supply system that has no or insufficient available specifications, one or more generic water filtration systems are them recommended, which may include particular features.

The present invention may also include information on purchasing the one or more water filtrations systems recommended, as shown at step 29. The present invention may also include information on installation of the one or more water filtration systems recommended, at step 32.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method of matching water supply systems with water filtration systems comprising the steps of:
having a user provide area location identification,
determining the water supply system for the identified area,
referencing available water specifications for the water supply system, and
providing the user with a recommendation of one or more water filtrations systems.

2. A method of matching water supply systems with water filtrations systems as in claim 1 further comprising the step of:
providing the user information on purchasing one or more of the recommended one or more water filtrations systems.

3. A method of matching water supply systems with water filtrations systems as in claim 1 further comprising the step of:
providing the user information on installing one or more of the recommended one or more water filtrations systems.
